(19) United States
(12) Patent Application Publication
(10) Pub. No.: US 2003/0131095 A1
(43) Pub. Date: Jul. 10, 2003

(54) System to prevent inappropriate display of advertisements on the internet and method therefor

(75) Inventors: David Bruce Kumhyr, Austin, TX (US); Gregory Peter Davis, Raleigh, NC (US)

Correspondence Address: Barry S. Newberger, 5400 Renaissance Tower, 1201 Elm Street, Dallas, TX, 75270, US

(73) Assignee: International Business Machines Corporation, Armonk, NY (US)

(21) Appl. No.: 10/045,322

(22) Filed: Jan. 10, 2002

(51) Int. Cl. G06F 15/173

(52) U.S. Cl. 709/224

(57) ABSTRACT

Systems and methods for avoiding the inappropriate display of advertisements are implemented. These include, respectively, circuitry and steps for include, respectively, circuitry and steps for watching a datastream representing a page for delivery to a client via a network. It is determined if an advertisement subject to display restrictions is identified in the datastream. It is further determined if the advertisement is restricted from being displayed in the page in response to a content analysis of the datastream.

### TECHNICAL FIELD

The present invention relates in general to data processing systems, and in particular, to data processing systems for generating and supplying information and associated advertising to a client via a public-wide area network, such as the Internet.

### BACKGROUND INFORMATION

The development of computerized distribution information systems, such as the Internet, allows users to link with servers and networks, and thus retrieve vast amounts of electronic information that was previously unavailable using conventional electronic media.

Users may be linked to the Internet through a hypertext based service commonly referred to as the World Wide Web (WWW). (The WWW may also be used in a broader sense to refer to the whole constellation of resources that can be accessed using one or more of the protocols that embody the TCP/IP suite, described further below.) With the World Wide Web, an entity may register a domain name @ correlated with an electronic address (referred to an IP address) representing a logical node on the Internet and may create a “web page” or “page” that can provide information and some degree of interactivity.

The Internet is based upon a suite of communication protocols known as Transmission Control Protocol/Internet Protocol (TCP/IP) which sends packets of data between a host machine, such as a server computer on the Internet commonly referred to as web server, and a client machine, such as user's computer connected to the Internet. The WWW communications may typically use the Hypertext Transfer Protocol (HTTP) which is supported by the TCP/IP transmission protocols, however, file transfer and other services via the WWW may use other communication protocols, for example the File Transfer Protocol (FTP).

A computer user may “browse”, i.e., navigate around, the WWW by utilizing a suitable web browser, e.g., NetscapeJ, Internet ExplorerJ, and a network gateway, e.g., Internet Service Provider (ISP). A web browser allows the user to specify or search for a web page on the WWW and subsequently retrieve and display web pages on the user's computer screen. Such web browsers are typically installed on personal computers or workstations to provide web client services, but increasingly may be found on other wired devices, for example personal digital assistants (PDA) or wireless devices such as cell phones. As noted above, transactions between Web client and server may be dynamic, in particular, the advertising content may be dynamically selected. In other words, advertising and similar promotional materials provided by a sponsor may be selected and incorporated into the web page, that is, the HTML or similar file may be dynamically selected in response to the predetermined criteria, or policies, established by the content provider. For example, advertising copy may be selected for insertion into the content to be communicated to the client based on the geographic location of the client, or, alternatively, the content provider may select advertising based on sponsor, or subscriber, fulfillment requirements. In other words, the content provider may simply incorporate advertising into the pages based on each sponsors pro rata share of the request for the particular page. Additionally, a Web page provider may use customer relationship data, such as cookies, or a history of topics browsed by a particular userid, to push advertising. However, incorporating advertising into web page content in this way may occasion a negative association of the advertisers product or service with the content of the page. For example, a web page reporting news content which includes copy related to a news report detailing a criminal act may create a negative association with an ad for a product which, coincidentally, was used in the perpetration of the crime. Consequently, there is a need in the art for a mechanism which provides some control by the sponsor of advertising to be delivered in association with web page content to mitigate against the association of the sponsors advertising with content that may create a negative association with the advertiser's product or service.

### SUMMARY OF THE INVENTION

The aforementioned needs are addressed by the present invention. Accordingly, there are provided systems and methods for avoiding inappropriate display of advertisements that include, respectively circuitry and steps for watching a datastream representing a page for delivery to a client via a network. It is determined if an advertisement subject to display restrictions is identified in the datastream. It is further determined if the advertisement is restricted from being displayed in the page in response to a matching against a content analysis of the datastream.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates, in block form, a client-server environment which may be used with the present invention;

FIG. 2 illustrates, in block form, a data processing system which may be used with an embodiment of the present invention;

FIG. 3 illustrates, in flowchart form, a methodology for preventing inappropriate display or advertising in accordance with the principles of the present invention;

FIG. 4 illustrates, in flowchart form, a page scan methodology which may be used with the methodology of FIG. 3;

FIG. 5 schematically illustrates matching ranges in accordance with the present inventive principles; and

FIG. 6 illustrates, in flowchart form, an exception methodology which may be used with the scan methodology of FIG. 4.

### DETAILED DESCRIPTION

In the following description, numerous specific details are set forth. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

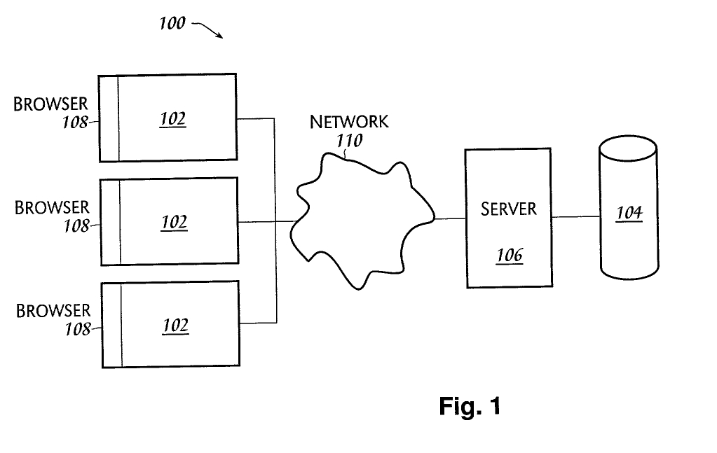

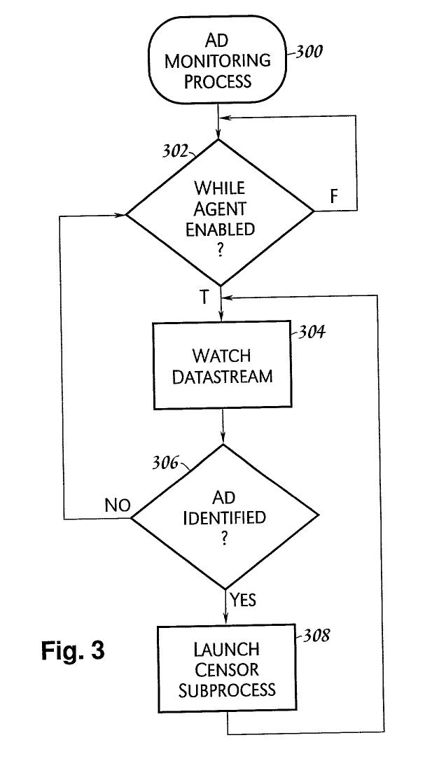

Referring to FIG. 1, there is illustrated a Web client-server system 100, in accordance with the principles of the present invention. System 100 includes one or more clients 102. Access to Web document data 104 is mediated via server 106. Clients 102 may be coupled to server 106 via network 110, which may be a local area network (LAN), wide area network (WAN), or the Internet. Clients 102 may include a Web browser 108 for requesting Web documents, which may also be referred to as Web pages, from server 106 and rendering the requested Web pages as previously described. Server 106 may incorporate mechanisms for avoiding inappropriate display of advertisements in Web pages in accordance with the present inventive principles described in further detail in conjunction with FIGS. 3-6 hereinbelow.

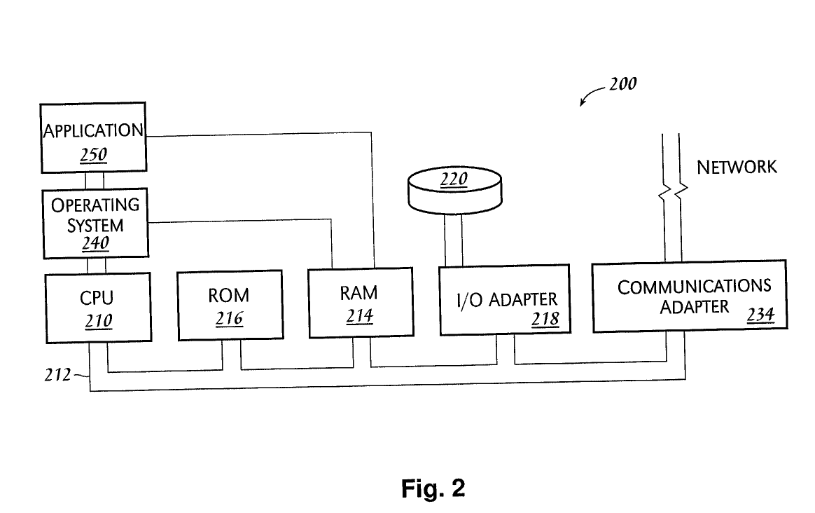

Refer now to FIG. 2 that illustrates a server 200 in accordance with the principles of the present invention. Server 200 may be used in an embodiment of servers 104, FIG. 1. Server 200 may include a central processing unit (CPU) 210 coupled to various other components by system bus 212. An operating system (OS) 240 runs on CPU 210 and provides control and coordinates the function of the various components in FIG. 2. In an embodiment of a server 106, application 250 may include mechanisms for avoiding inappropriate display of advertisements in accordance with the principles of the present invention and which will be described further in conjunction further with FIGS. 3-6 hereinbelow. Application 250 runs in conjunction with OS 240, which coordinates the internal functions of server 200, and may provide services to application 250 as would be understood by those of ordinary skill in the art.

Additionally, read only memory (ROM) 216 is coupled to system bus 212 and includes a basic input/output system (BIOS) that control certain basic functions of server 200. Random access memory (RAM) 214, I/O adapter 218 and communications adapter 234 are also coupled to system bus 212. It should be noted that software components including OS 240 and application 250 are loaded into RAM 214 which is the computer systems main memory. Disk adapter 218 may be a Universal Serial Bus (USB) or other adapter that communicates with disk units 220. It is noted that the program of the present invention may reside in disk unit 220 and loaded into RAM 214 by operating system 240, as required. Communications adapter 234 interconnects bus 212 with a network, such as network 110, FIG. 1.

Implementations of the invention include implementations as a computer system programmed to execute the method or methods described herein, and as a computer program product. According to the computer system implementations, sets of instructions for executing the method or methods are resident in the random access memory 214 of one or more computer systems configured generally as described above. And to require by server 200, the set of instructions may be stored as a computer program product in another computer memory, for example in disk drive 220 (which may include a removable memory such as an optical disk or floppy disk for eventual use in disk drive 220). Furthermore, the computer program product can also be stored in another computer and transmitted when desired to the work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

The flowcharts provided herein are not necessarily indicative of the serialization of operations being performed in an embodiment of the present invention. Steps disclosed within these flowcharts may be performed in parallel. The flowcharts are indicative of those considerations that may be performed to produce the operations available on the display of advertisements in a page. It is further noted that the order presented is illustrative and does not necessarily imply that the steps must be performed in order shown.

Although the present invention and its advantages have been described in detail, it should be understood that various changes, substitutions and alterations can be made herein without departing from the spirit and scope of the invention as defined by the appended claims.

Referring now to FIG. 3, there is illustrated therein an advertising (Ad) monitoring process 300 in accordance with the principles of the present invention. Monitoring process 300 may be used to monitor web pages for content deemed inappropriate by the sponsor of advertising to be inserted in the web page as discussed hereinabove. The monitoring process 300, or “watcher” may be enabled all the time, or alternatively may be selectively enabled. In step 302, process 300 idles if not enabled. Otherwise, steps 304-308 are performed.

In step 304, a data stream is watched as the web page is generated. This data stream, may for example, be a stream of HTML, XML, Java Server Pages (JSP) or other formatted text generated by the page content generator. Additionally digital images incorporated in the page, either referenced or down loaded, may be watched via the data segment of the digital image recorded in a header, using a data segment reader, for example an EXIF reader which needs the data segment of image files formatted in accordance with the Exchangeable Image File Format.

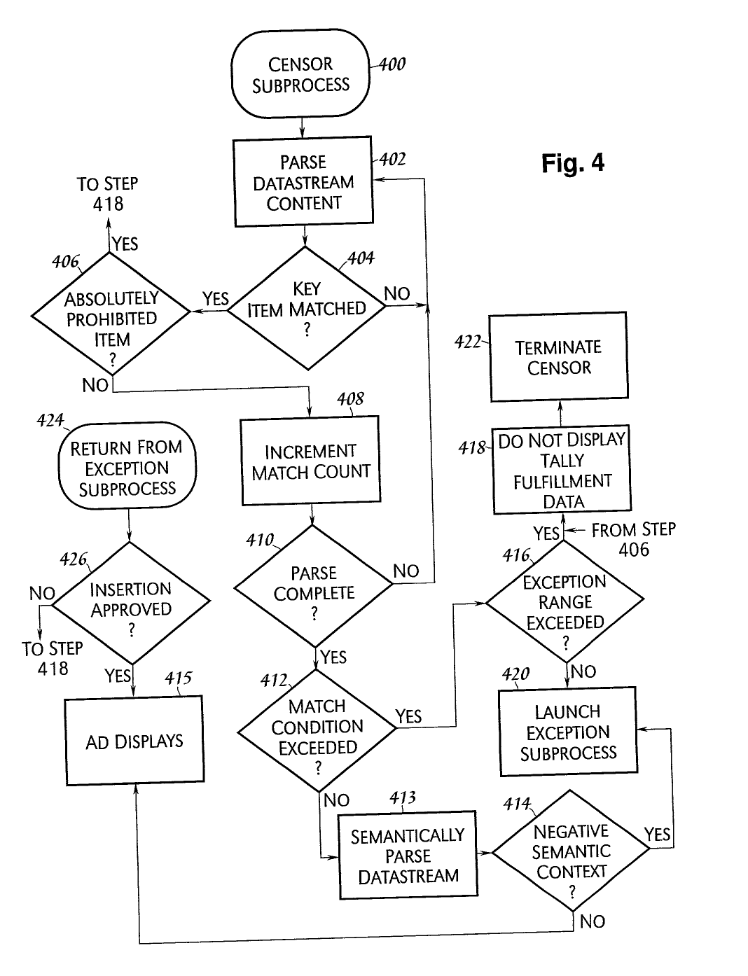

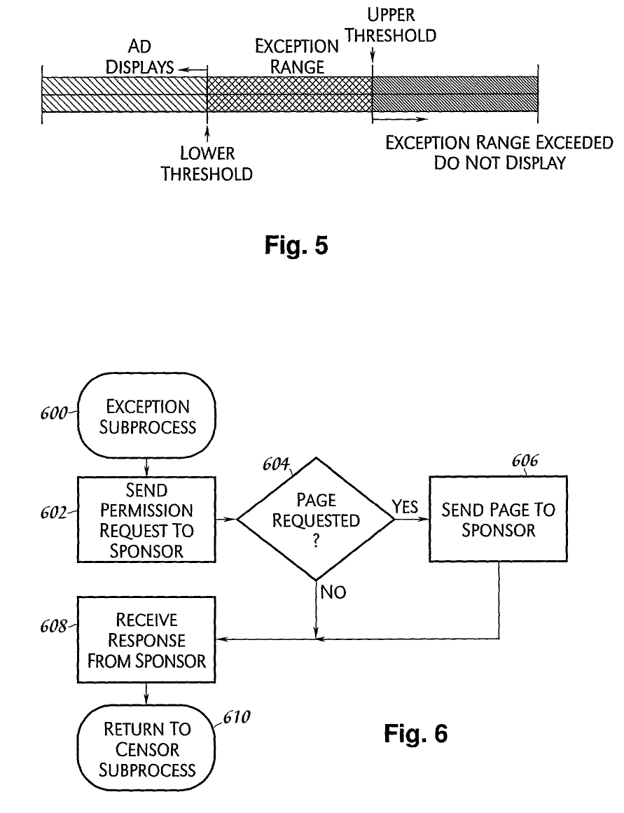

A Web page may be have multiple insertions of advertising, and not all of the entities placing the advertising are necessarily concerned about the content of the web page in which the advertising will appear. Conversely, a particular advertiser concerned about the placement of its advertising in a web page including content it considers inappropriate, may subject its advertisements to display restrictions. Thus, in step 306, it is determined if an advertisement associated with such display restrictions is identified in the page. If so, in step 308, a censor subprocess, discussed hereinbelow in conjunction with FIGS. 4 and 5 is launched, and returns to step 304. Otherwise, in step 306, process 300 returns to step 302 to monitor additional web pages.

Refer now to FIG. 4 illustrating, in flowchart form, censor subprocess 400 in accordance with the present inventive principles Censor process 400 may be used to provided the censor subprocess launched in step 308, FIG. 3.

In step 402, process 400 enters a scanning loop formed by steps 402-410 in which the datastream content is parsed for instances of key items in the web page content. For example, key items may include sexuality explicit content, or content associated with certain specific material, such as, negative news reports with references with goods or services of the same kind or category as the advertiser's goods or services, or content with respect to particular individuals with whom a negative connotation may be associated. Note that different key items may be associated with different advertisements by the same sponsor. In other words, a set of key items may be associated with a particular advertisement. Alternatively, a sponsor may have a list that applies to all of its advertisements, or in another alternative a default list of key items may be used. If such key items are matched in the page content, in step 404, in step 406 it is determined if it is prohibited item. An advertiser may identify particular items, for example, sexually explicit material, regardless of the extent to which such items appear in the page content. If such items are found, process 400 proceeds to step 418, which will be described hereinbelow. Otherwise, if the key item matched is not an absolutely a prohibited item then, in step 408 a match count is incremented.

In step 410 it is determined if the parse of the page is complete. If not, process 400 loops back to step 402 and continues matching key items by looping over steps 404, 406, and 408.

On completion of the scan, step 410, in step 412 it is determined if a match condition is exceeded. In other words, if a match of count of key items exceeds a predetermined threshold condition. If not, in step 413, the datastream is semantically parsed. (Note that the semantic parsing of the datastream may be performed substantially in parallel with the parsing of the datastream against the list of key items, steps 402-410, and the results applied if the match condition is not exceeded (step 412).)

Even if the display of an advertisement might not be restricted based on a key-item matching basis, an advertiser may not want to display its advertising in a page that has a negative context. For example, a technology company may not want to display its advertising in an article that presents a negative portrayal of technology. This may be so even if there is no particular reference to the company's products specifically, area of technology generally. If such a semantic context is identified, step 414, an exception subprocess is launched (step 420). (The exception subprocess will be discussed further hereinbelow.) Otherwise, the ad displays, step 415.

If, however, in step 412 the match condition is exceeded, it is determined in step 416 if an exception range is exceeded. The exception range provides an interval that larger than a match condition interval whereby further refinement of the determination whether the advertisement is to displayed may be made.

This may be further understood by referring to FIG. 5, which schematically illustrates a range of key item matches. For range of key item matches less than a lower threshold matched condition, denoted by singly hatched region, the ad may display (corresponding to step 414, FIG. 4). If however the key item matches fall within the exception range, denoted by the cross hatching, a more refined review may be warranted, as described hereinbelow. If, the exception range is exceeded, that is in the range above a predetermined upper threshold denoted by the solid shading, the ad will not display. Returning to FIG. 4, this corresponds to step 418 in FIG. 4, via the “Yes” branch of step 416. Additionally, in step 418, for an ad not displayed, fulfillment data is tallied. That is, a particular advertiser may have in its contract with the page content provider, requirements that an advertisement appear a certain number of times, or similar fulfillment requirements. If an ad is scheduled for display is not displayed, such an non-display of the advertisement may implicate such fulfillment requirements. Fulfillment data tallied in step 418, may be used to alert a content provider that the scheduling of advertising for display may have been affected by the non-display of the advertising because the unsuitability of the content of the page. Process 400 then terminates in step 422.

Returning to step 416, if, the key item matches falls within the exception range, then in step 420, an exception subprocess is launched. As will be discussed further hereinbelow, in conjunction with FIG. 6, the exceptions of process provides for a more refined determination of the suitability of the content for display of the advertising.

In step 424, the subprocess returns. If the ad insertion has been approved, then the ad displays, step 414, otherwise, process 400 proceeds to step 418, discussed hereinabove.

Refer now to FIG. 6 illustrating an exception subprocess 600 in accordance with the principles of the present invention. In step 602, a display permission request is sent to the advertisers sponsor, or advertiser (these terms may be used equivalently herein). The permission request may be sent to the sponsor via any available communication means. For example, the request may be sent via the network itself, via telephonic, or facsimile and may be conveyed by either wired or wireless modes. The request may include, for example, the number of key items matched, and a list of the key items that were matched in the page. The request may also include the semantic analysis from the semantic parsing of the datastream, step 413 (FIG. 4). Optionally, the sponsor may request a copy of the web page. In step 604, if the web page is requested, in step 606 the page is transmitted to the sponsor. Alternatively, the datastream may be transmitted to the advertiser for evaluation, or in yet another alternative, the page may be popped up on the advertisers console, analogous to the time delay used in the radio broadcast industry. Otherwise, if the sponsor has not requested the page, step 606 is bypassed. In step 608, the response, either authorizing or not authorizing display of the advertisement is received from the sponsor, and in step 610 the response is returned to the censor process, such as censor process 400, FIG. 4.

What is claimed is:

1. A method comprising the steps of:
watching a datastream representing a page for delivery to a client via a network;
determining if an advertisement subject to display restrictions is identified in said datastream; and
determining if said advertisement is restricted from being displayed in said page in response to a content analysis of said datastream.

2. The method of claim 1 wherein said content analysis of said datastream comprises a matching against a predetermined set of key items.

3. The method of claim 2 wherein said step of determining if said advertisement is displayed comprises the step of scanning said page for instances of said key items.

4. The method of claim 2 wherein said step of determining if said advertisement is displayed includes the steps of:
determining a number of matched key items in content of said page; and
determining if said number of matched key items is less than a predetermined lower threshold.

5. The method of claim 4 wherein said advertisement is displayed if said number of matched key items is less that said predetermined lower threshold.

6. The method of claim 4 further comprising the step of, if said number of matched key items is not less that said predetermined lower threshold, determining if said number of matched key items is not less than a predetermined upper threshold, and wherein said advertisement does not display if said number of matched key items is not less than said predetermined upper threshold.

7. The method of claim 6 wherein said lower threshold does not equal said upper threshold, the method further comprising the step of, if said number of matched key items is greater than said predetermined lower threshold and less than said predetermined upper threshold, launching an exception process, wherein said exception process for determining if said advertisement is displayed in accordance with a permission received from a sponsor of said advertisement.

8. The method of claim 6 further comprising the step of tallying fulfillment data if said advertisement does not display.

9. The method of claim 1 wherein said content analysis of said datastream comprises a semantic parsing of said datastream.

10. A computer program product embodied in a machine readable storage medium, the program product comprising a program of instructions for performing the steps of:
watching a datastream representing a page for delivery to a client via a network;
determining if an advertisement subject to display restrictions is identified in said datastream; and
determining if said advertisement is restricted from being displayed in said page in response to a content analysis of said datastream.

11. The program product of claim 10 wherein said content analysis of said datastream comprises a matching against a predetermined set of key items.

12. The program product of claim 11 wherein said instructions for performing the step of determining if said advertisement is displayed comprises instructions for performing the step of parsing said page for instances of said key items.

13. The program product of claim 12 wherein said instructions for step of determining if said advertisement is displayed includes the instructions for performing the steps of:
determining a number of matched key items in content of said page; and
determining if said number of matched key items is less than a predetermined lower threshold.

14. The program product of claim 13 wherein said advertisement is displayed if said number of matched key items is less that said predetermined lower bound.

15. The program product of claim 13 further comprising instructions for, if said number of matched key items is not less that said predetermined lower threshold, performing the step of determining if said number of matched key items is not less than a predetermined upper threshold, and wherein said advertisement does not display if said number of matched key items is not less than said predetermined upper threshold.

16. The program product of claim 15 wherein said lower threshold does not equal said upper threshold, the program product further comprising instructions for performing the step of, if said number of matched key items is greater than said predetermined lower threshold and less than said predetermined upper threshold, launching an exception process, wherein said exception process for determining if said advertisement is displayed wherein said exception process for determining if said advertisement is displayed in accordance with a permission received from a sponsor of said advertisement.

17. The program product of claim 15 further comprising instructions for performing the step of tallying fulfillment data if said advertisement does not display.

18. The program product of claim 10 wherein said content analysis of said datastream comprises a semantic parsing of said datastream.

19. A system, comprising:
a memory unit operable for storing a computer program operable for generating pages; and
a processor coupled to said memory unit, wherein said processor, responsive to said computer program, comprises:
circuitry operable for watching a datastream representing a page for delivery to a client via a network;
circuitry operable for determining if an advertisement subject to display restrictions is identified in said datastream; and
circuitry operable for determining if said advertisement is restricted from being displayed in said page in response to content analysis of said datastream.

20. The system of claim 19 wherein said content analysis of said datastream comprises a matching against a predetermined set of key items.

21. The system of claim 20 wherein said circuitry operable for determining if said advertisement is displayed comprises circuitry operable for parsing said page for instances of said key items

22. The system of claim 21 wherein said circuitry operable for determining if said advertisement is displayed includes:
circuitry operable for determining a number of matched key items in content of said page; and
circuitry operable for determining if said number of matched key items is less than a predetermined lower threshold.

23. The system of claim 22 wherein said advertisement is displayed if said number of matched key items is less that said predetermined lower bound.

24. The system of claim 22 wherein said processor, responsive to said computer program, further comprises circuitry operable for, if said number of matched key items is not less that said predetermined lower threshold, determining if said number of matched key items is not less than a predetermined upper threshold, and wherein said advertisement does not display if said number of matched key items is not less than said predetermined upper threshold.

25. The system of claim 24 wherein said lower threshold does not equal said upper threshold, the processor, responsive to said computer program, further comprises circuitry operable for, if said number of matched key items is greater than said predetermined lower threshold and less than said predetermined upper threshold, launching an exception process, wherein said exception process for determining if said advertisement is displayed wherein said exception process for determining if said advertisement is displayed in accordance with a permission received from a sponsor of said advertisement.

26. The system of claim 24 wherein said processor, responsive to said computer program, further comprises circuitry operable for tallying fulfillment data if said advertisement does not display.

27. The system of claim 19 wherein said content analysis of said datastream comprises a semantic parsing of said datastream.

28. A method comprising:
watching a datastream representing a page for delivery to a client via a network;
determining if an advertisement subject to display restrictions is identified in said datastream;
determining if said advertisement is displayed in said page in response to a predetermined set of key items, wherein said step of determining if said advertisement is displayed includes the steps of:
determining a number of matched key items in content of said page; and
determining if said number of matched key items is less than a predetermined lower threshold; and
if said number of matched key items is not less that said predetermined lower threshold, determining if said number of matched key items is not less than a predetermined upper threshold, and wherein said advertisement does not display if said number of matched key items is not less than said predetermined upper threshold.
